(19) United States
(12) Patent Application Publication
(10) Pub. No.: US 2025/0352929 A1
(43) Pub. Date: Nov. 20, 2025

(54) WATER FILTRATION SYSTEM INCLUDING A MODULAR FLOW METER FOR AN APPLIANCE

(71) Applicant: Haier US Appliance Solutions, Inc., Wilmington, DE (US)

(72) Inventors: Timothy Ray Jackson, Louisville, KY (US); Benjamin Darpel, Louisville, KY (US)

(21) Appl. No.: 18/665,016

(22) Filed: May 15, 2024

(51) Int. Cl. B01D 29/60; B01D 29/11; B01D 35/143; B01D 35/147; C02F 1/00; F25D 23/12

(52) U.S. Cl. CPC B01D 29/603; B01D 29/11; B01D 35/143; B01D 35/147; C02F 1/003; F25D 23/126; C02F 2201/005; C02F 2209/40; C02F 2209/445; C02F 2301/043; C02F 2307/12; F25D 2323/121; F25D 2400/361

(57) ABSTRACT

A measurement module for a water filtration system including a filter body having at least one body electrical contact. The measurement module includes a module electrical contact selectively coupled with the at least one body electrical contact to transfer electrical signals between the measurement module and the filter body; and a fluid flow measuring device configured to determine an amount of fluid passing through the water filtration system, the fluid flow measuring device receiving electrical power from the filter body.

### FIELD OF THE INVENTION

The present subject matter relates generally to refrigerator appliances, and more particularly to removable accessories for water filters for refrigerator appliances.

### BACKGROUND OF THE INVENTION

Refrigerator appliances generally include a cabinet that defines a chilled chamber. A wide variety of food items may be stored within the chilled chamber. The low temperature of the chilled chamber relative to ambient atmosphere assists with increasing a shelf life of the food items stored within the chilled chamber. Refrigerator appliances may also be equipped with a dispensing system. Such dispensing systems typically provide chilled water and/or ice from inside of the refrigerator appliance to a dispensing outlet accessible from inside or outside of the refrigerator appliance.

Certain refrigerator appliances further include water filter assemblies for filtering water. Water filter assemblies can filter water entering the refrigerator appliances to provide filtered water to various refrigerator appliance components, such as an ice maker and/or a water dispenser of the aforementioned dispensing system. Such filtering can improve a taste and/or an appearance of water within the refrigerator appliances. Over time, water filter assemblies (such as water filter cartridges) become fouled and no longer properly filter water supplied thereto. For instance, after a certain amount or volume of water has passed through the filter media, the water filter may no longer be usable. However, existing methods of monitoring the life of a water filter exhibit drawbacks. For one, expensive flow meters are installed into the appliance itself, occupying cabinet space and increasing the cost of the appliance.

Accordingly, a water filtration system which obviates one or more of the above-mentioned drawbacks would be beneficial. In particular, a water filtration system with selective flow monitoring and control would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a water filtration system for a domestic appliance is provided. The domestic appliance may include a receiving compartment. The water filtration system may include a filter body defining an axial direction, a radial direction, and a circumferential direction, the filter body including a first body electrical contact configured to transfer electrical signals between the domestic appliance and the filter body and a second body electrical contact positioned opposite the first body electrical contact, the second body electrical contact being electrically connected with the first body electrical contact; and a measurement module removably coupled to the filter body at a first axial end thereof, the measurement module being connectable to the domestic appliance. The measurement module may include a module electrical contact selectively coupled with the second body electrical contact to transfer electrical signals between the measurement module and the filter body; and a fluid flow measuring device configured to determine an amount of fluid passing through the water filtration system, the fluid flow measuring device receiving electrical power from the domestic appliance via the filter body.

In another exemplary aspect of the present disclosure, a measurement module for a water filtration system is provided. The water filtration system may include a filter body having at least one body electrical contact. The measurement module may include a module electrical contact selectively coupled with the at least one body electrical contact to transfer electrical signals between the measurement module and the filter body; and a fluid flow measuring device configured to determine an amount of fluid passing through the water filtration system, the fluid flow measuring device receiving electrical power from the filter body.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides an elevation view of a refrigerator appliance according to exemplary embodiments of the present disclosure.

FIG. 2 provides a perspective view of the exemplary refrigerator appliance of FIG. 1.

FIG. 3 provides an elevation view of the exemplary refrigerator appliance of FIG. 1, wherein the doors are shown in an open position.

FIG. 4 provides a simplified side elevation view of an embodiment of a water filtration assembly within a refrigerator appliance according to exemplary embodiments of the present disclosure.

FIG. 5 provides a perspective view of a water filtration assembly, including an illustration of a second electrical contact sub-assembly separated from the rest of the water filtration assembly for clarity.

FIG. 6 provides an exploded perspective view of the exemplary water filtration assembly of FIG. 5.

FIG. 7 provides an exploded schematic illustrating a water filter body, a measurement module, and a manifold of a water filtration system according to an exemplary embodiment of the present disclosure.

FIG. 8 provides an exploded schematic illustrating a water filter body, a measurement module, and a manifold of a water filtration system according to another exemplary embodiment of the present disclosure.

FIG. 9 provides a schematic of a water filter body and a measurement module of a water filtration system according to an exemplary embodiment of the present disclosure.

FIG. 10 provides an exploded schematic illustrating a water filter body and a measurement module of a water filtration system according to another exemplary embodiment of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

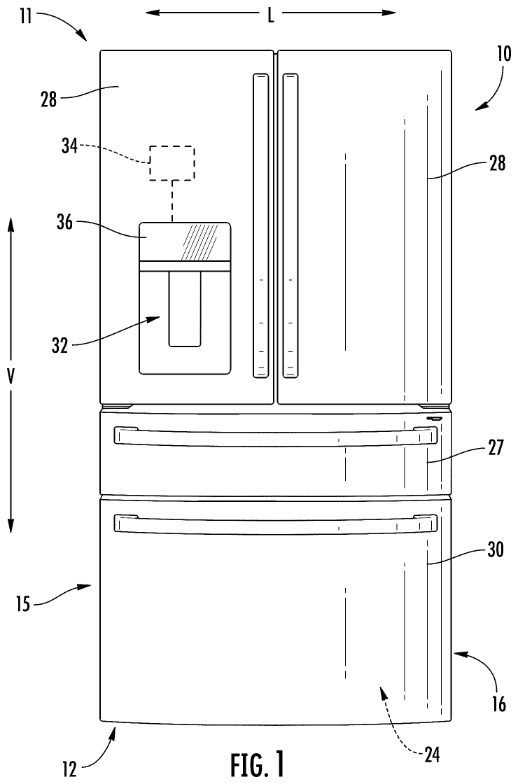

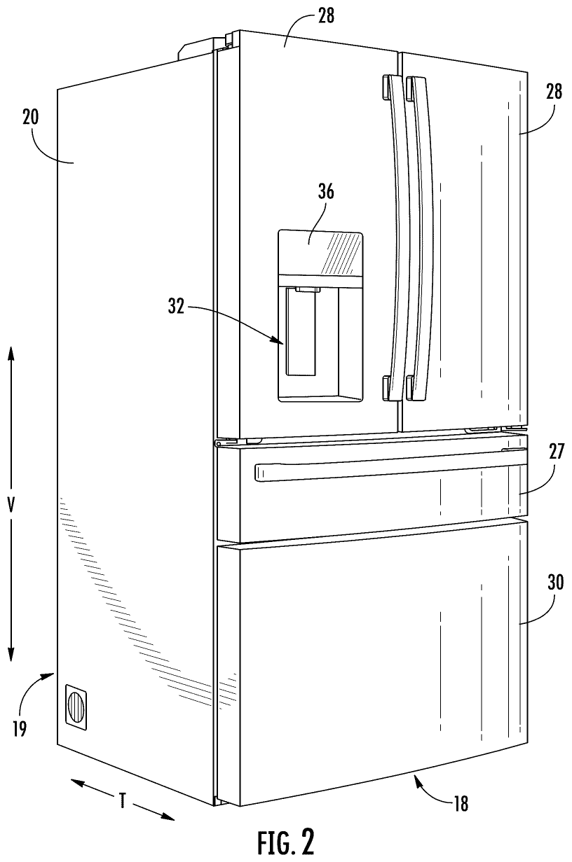

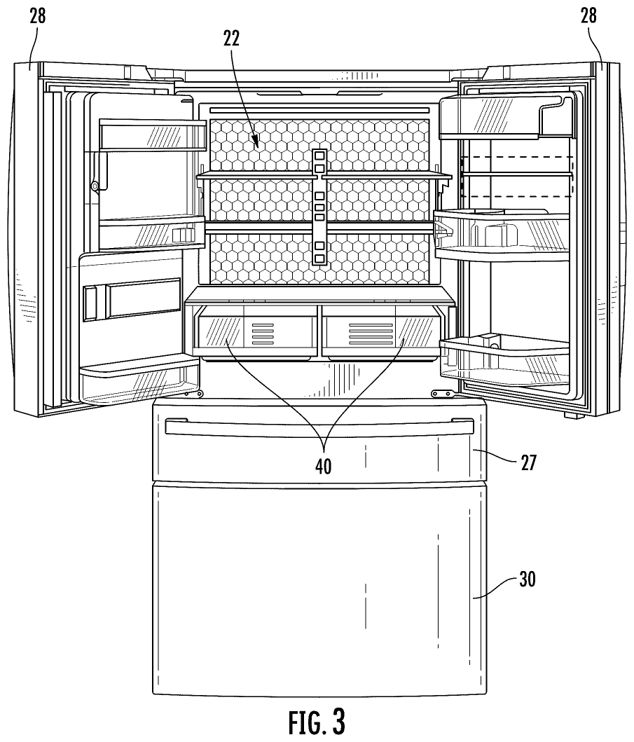

Referring now to the drawings, FIG. 1 illustrates a front view of an embodiment of a refrigerator appliance 10 according to the present disclosure. FIG. 2 illustrates a perspective view of refrigerator appliance 10 of FIG. 1. FIG. 3 illustrates a front view of refrigerator appliance 10 of FIG. 1 with refrigerator doors 28 in an open position. Referring particularly to FIG. 1, refrigerator appliance 10 extends between a top 11 and a bottom 12 along a vertical direction V. Refrigerator appliance 10 also extends between a first side 15 and a second side 16 along a lateral direction L. As shown in FIG. 2, a transverse direction T may additionally be defined perpendicular to the vertical and lateral directions V, L. Refrigerator appliance 10 extends along the transverse direction T between a front portion 18 and a back portion 19.

Refrigerator appliance 10 may include a cabinet or housing 20 (FIG. 2) defining a fresh food chamber 22 (FIG. 3) and a freezer storage chamber 24 arranged below the upper fresh food chamber 22 along the vertical direction V. An auxiliary food storage chamber may be positioned between fresh food chamber 22 and freezer storage chamber 24, e.g., along the vertical direction V. Because freezer storage chamber 24 is positioned below fresh food chamber 22, refrigerator appliance 10 may be generally referred to as a bottom mount refrigerator. In the embodiment, housing 20 may also define a mechanical compartment (not shown) for receipt of a sealed cooling system (not shown). Using the teachings disclosed herein, one of ordinary skill in the art will understand that the present technology can be used with other types of refrigerators (e.g., side-by-side) or a freezer appliance as well. Consequently, the description set forth herein is for illustrative purposes only and is not intended to limit the technology in any aspect.

Referring now particularly to FIG. 3, refrigerator doors 28 may each be rotatably hinged to an edge of housing 20 for accessing fresh food chamber 22. It should be noted that while two refrigerator doors 28 in a “French door” configuration are illustrated, any suitable arrangement of doors utilizing one, two or more doors is within the scope and spirit of the present disclosure. A freezer door 30 may be arranged below refrigerator doors 28 for accessing freezer storage chamber 24. In the embodiment, freezer door 30 is coupled to a freezer drawer (not shown) slidably mounted within freezer storage chamber 24. An auxiliary door 27 may be coupled to an auxiliary drawer which may be slidably mounted within the auxiliary chamber.

Referring back to FIG. 1, operation of the refrigerator appliance 10 may be regulated by a controller 34 that is operatively coupled to a user interface panel 36. User interface panel 36 may provide selections for user manipulation of the operation of refrigerator appliance 10 to modify environmental conditions therein, such as temperature selections, etc. In some embodiments, user interface panel 36 is proximate a dispenser assembly 32. In response to user manipulation of user interface panel 36, controller 34 may operate various components of refrigerator appliance 10. Operation of refrigerator appliance 10 may be regulated by controller 34, e.g., controller 34 may regulate operation of various components of refrigerator appliance 10 in response to programming and/or user manipulation of user interface panel 36.

Controller 34 may include a memory and one or more microprocessors, CPUs or the like, such as general or special purpose microprocessors operable to execute programming instructions or micro-control code associated with operation of refrigerator appliance 10. The memory may represent random access memory such as DRAM, or read only memory such as ROM or FLASH. In one embodiment, the processor executes programming instructions stored in memory. The memory may be a separate component from the processor or may be included onboard within the processor. It should be noted that controller(s) 34 as disclosed herein are capable of and may be operable to perform any methods and associated method steps as disclosed herein.

Controller 34 may be positioned in a variety of locations throughout refrigerator appliance 10. In the illustrated embodiment, controller 34 is located within one of the refrigerator doors 28. In such an embodiment, input/output (“I/O”) signals may be routed between the controller and various operational components of refrigerator appliance 10. In one embodiment, user interface panel 36 represents a general purpose I/O (“GPIO”) device or functional block. In one embodiment, user interface panel 36 includes input components, such as one or more of a variety of electrical, mechanical or electro-mechanical input devices including rotary dials, push buttons, and touch pads. User interface panel 36 may include a display component, such as a digital or analog display device designed to provide operational feedback to a user. For example, user interface panel 36 may include a touchscreen providing both input and display functionality. User interface panel 36 may be in communication with controller 34 via one or more signal lines or shared communication busses.

Using the teachings disclosed herein, one of skill in the art will understand that the present disclosure can be used with other types of refrigerators such as a refrigerator/freezer combination, side-by-side, bottom mount, compact, and any other style or model of refrigerator appliance. Accordingly, other configurations of refrigerator appliance 10 could be provided, it being understood that the configurations shown in the accompanying figures and the description set forth herein are by way of example for illustrative purposes only.

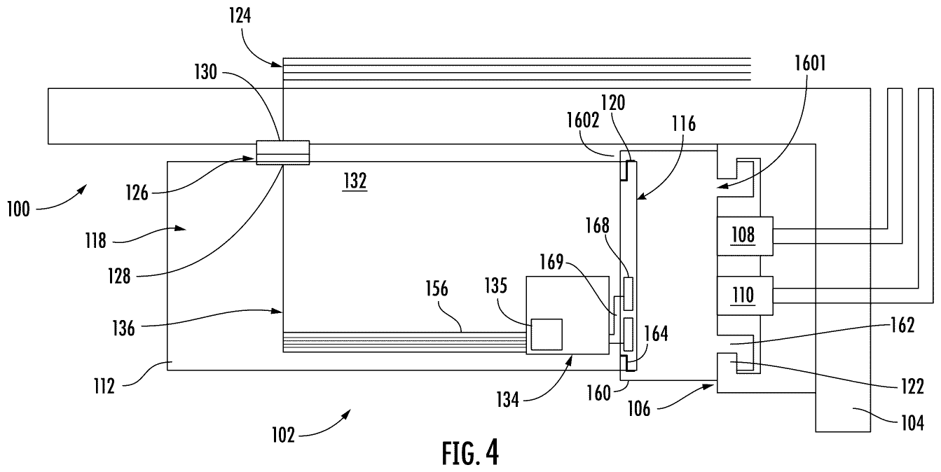

Referring now to FIG. 4, a simplified side view of an embodiment of an appliance wall 104 of an appliance 100 (such as an interior wall, an exterior wall, a side wall, etc.) having a water filtration assembly or system 102 secured thereto according to the present disclosure is illustrated. In particular, as shown, water filtration system 102 includes a filter body 112 and a water filtration media (not shown) within filter body 112. In addition, as shown, filter body 112 may have a cylindrical configuration. Accordingly, water filtration system 102 may define an axial direction A, a radial direction R, and a circumferential direction C. In further embodiments, filter body 112 may have any other suitable configuration other than a cylindrical configuration. Moreover, as shown, water filtration system 102 may also include a liquid receiving space 132 within filter body 112 and an electronics compartment 134 having one or more electronic components (not shown) housed, at least in part, therein. In such embodiments, electronics compartment 134 is fluidly isolated from liquid receiving space 132, and thus fluidly isolated from the flow of water received within liquid receiving space 132.

In further embodiments, as shown, water filtration system 102 includes a manifold 106 that may be mounted to the appliance wall 104 of the appliance 100. Accordingly, as shown, manifold 106 may generally contain a filter latching/mating interface and water connections therein.

Furthermore, appliance 100 may generally include a water source (not shown) that provides water to and from water filtration system 102, e.g., through manifold 106 via a water inlet 108 and a water outlet 110. Thus, in certain embodiments, water filtration system 102 is in fluid communication with water inlet 108 and water outlet 110.

In further embodiments, filter body 112 includes a first end (or first axial end) 116 opposite a second end (or second axial end) 118. As such, in an embodiment, first end 116 is for securing water filtration system 102 to manifold 106 via the filter latching/mating interface, with manifold 106 being secured to appliance wall 104 of appliance 100. In particular embodiments, as shown in FIG. 4, the filter latching/mating interface may include first end 116 of filter body 112 having one or more interlocking features 120 and corresponding interlocking features 122 of manifold 106. In such embodiments, interlocking features 120 of first end 116 of filter body 112 may be configured to engage with the corresponding interlocking features 122 of manifold 106 for securing filter body 112 to appliance 100. In further embodiments, first end 116 of filter body 112 may be secured to manifold 106 using any suitable means.

According to some embodiments, water filtration system 102 may include a measurement module 160. Measurement module 160 may be separate from filter body 112. For instance, measurement module 160 may be removable from each of filter body 112 and manifold 106. Thus, measurement module 160 may be selectively attached between filter body 112 and manifold 106. Accordingly, measurement module 160 may include one or more interlocking features 162 (e.g., similar to interlocking features 120 of filter body 112) provided at a first axial end 1601 thereof.

Measurement module 160 may further include receiving features 164 provided at a second axial end 1602 thereof. For instance, filter body 112 may be at least partially accepted within measurement module 160 (e.g., along the axial direction A). Thus, measurement module 160 may at least partially surround filter body 112 along the radial direction R. Receiving features 164 may be configured to accept first end 116 of filter body 112 therein. For instance, interlocking features 120 may selectively mate with receiving features 164. According to at least some embodiments, first end 116 push snap fits within second end 1602 of measurement module 160 (i.e., no circumferential turning is required to attach filter body 112 to measurement module 160). Measurement module 160 will be described in more detail below.

Referring still to FIG. 4, water filtration assembly 102 further includes an electrical connection 126 electrically coupling water filtration assembly 102 to a power source (e.g., within appliance 10 or appliance 100) and/or a controller (e.g., controller 34 illustrated in FIG. 1 and described above). In certain embodiments, the power source may be any suitable source of electricity. More specifically, electrical connection 126 may include at least one first electrical contact 128 positioned on filter body 112 and at least one appliance electrical contact 130 positioned on appliance wall 104 of appliance 100. First electrical contact 128 may be a first body electrical contact and may include a plurality of contacts. In some instances, each of the plurality of contacts wraps around filter body 112 (e.g., along the circumferential direction C). Accordingly, first body electrical contact 128 may be configured to align with appliance electrical contact 130 when filter body 112 is mounted to appliance wall 104 regardless of an orientation of filter body 112, e.g., regardless of which side of filter body 112 is facing the appliance wall 104.

Furthermore, electrical connection 126 may include one or more electrical harnesses 136, 124. Accordingly, a first electrical harness 136 may be configured to electrically couple first body electrical contact 128 to an electronics compartment 134 having one or more electronic components housed within filter body 112. Moreover, a second electrical harness 124 may be configured to electrically couple appliance electrical contact 130 to the power source and/or any other communication device, such as a controller.

Furthermore, electrical connection 126 may be separate and spaced apart from manifold 106 and the flow of water received therein, e.g., separate and spaced apart from water inlet port(s) 108 and water outlet port(s) 110. As such, in an embodiment, when first body electrical contact(s) 128 contacts appliance electrical contact(s) 130, power may be provided to water filtration system 102 from the power source, for example, via electrical connection 126. In addition to providing power or in the alternative, one or more other signals for communication or sensing may also be provided to water filtration system 102 when first body electrical contact(s) 128 contacts appliance electrical contact(s) 130.

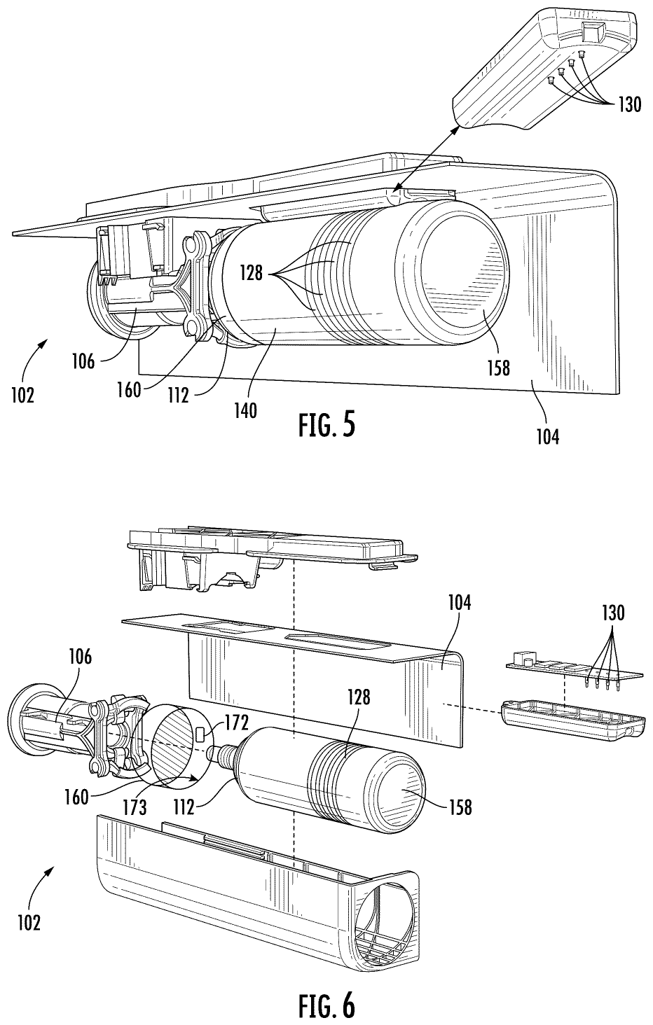

Turning now generally to FIGS. 5 and 6, a housing label 140 may be disposed on filter body 112. Generally, housing label 140 is separate and spaced apart from fluid inlet port 108 and fluid outlet port 110. For instance, housing label 140 may include an adhesive layer or coating (e.g., applied to an interior surface of the housing label 140) that adheres or sticks to an external surface of filter body 112. Additionally or alternatively, a separate exterior label or coating (e.g., fitted polymer, such as a shrink wrap or vacuum-sealed layer) may be provided to hold housing label 140 to filter body 112. Optionally, housing label 140 may extend about at least a portion of filter body 112. As would be understood, housing label 140 may include printed text, labeling, or figures indicative or descriptive of water filtration system 102. Nonetheless, as would also be understood, the present disclosure is not limited to any particular printed text, labeling, or figures.

First body electrical contact(s) 128 may include axially spaced pads. In particular, first body electrical contact(s) 128 may be formed or be shaped as one more conductive rings. For instance, first body electrical contact 128 may extend around at least a portion of filter body 112. Optionally, a plurality of first body electrical contacts 128 may be provided as conductive rings. In particular, as shown, water filtration assembly 102 may include a plurality of first body electrical contacts 128 extending around at least a portion of filter body 112. Optionally, a plurality of appliance electrical contacts 130 may be arranged on appliance wall 104 of appliance 100 (or 10, see FIG. 4).

In particular, as shown in the illustrated embodiments, each of the plurality of first body electrical contacts 128 may generally have a ring-shaped configuration extending around a circumference, e.g., an entire circumference or approximately the entire circumference (as noted above “approximately” includes a ten percent margin of error, e.g., approximately the entire circumference as used herein includes at least ninety percent of the circumference), of filter body 112. Accordingly, the ring-shaped first body electrical contact(s) 128 may allow for filter body 112 to be installed in any orientation such that, regardless of the orientation, first body electrical contact(s) 128 align with the appliance electrical contact(s) 130 (FIG. 4). In such embodiments, the ring-shaped first body electrical contacts 128 may be arranged adjacent to each other and may be spaced apart from each other along the axial direction A (e.g., equally spaced or separated by differing distances along the axial direction. In the illustrated embodiment, four first body electrical contacts 128 are provided, however, it should be understood that more than four or less than four first body electrical contacts 128 may be employed in the flexible circuit of the present disclosure.

Within the filtration housing 112, an internal electrical path 156 may be disposed in electrical communication with the intermediate electrical path 154. Specifically, the internal electrical path 156 may connect the intermediate electrical path 154 to the one or more electronics components 135 (FIG. 4) provided within the filtration housing 112 (e.g., within the electronics compartment 134-FIG. 4). For instance, one or more housing contact pads may be provided on (e.g., fixed on an external surface of) the filtration housing 112 to connect to the internal electrical path 156. In turn, the housing contact pads may be in electrical communication between the internal electrical path 156 and the intermediate electrical path 154.

Moreover, it should be understood that the number of appliance electrical contacts 130 (FIG. 4) generally corresponds to the number of first body electrical contacts 128, e.g., four appliance electrical contacts 130 may be provided to match with the illustrated four first body electrical contact 128. For example, each of the plurality of appliance electrical contacts 130 may be arranged on appliance wall 104 of appliance 100 (FIG. 4) to align with and contact one of the plurality of first body electrical contacts 128 when water filtration system 102 is mounted within appliance 100. In some embodiments, appliance electrical contacts 130 include or are provided as spring-loaded contact pins, such as pogo pins, biased outward or downward toward first body electrical contacts 128.

Filter body 112 may include a second body electrical contact 168. Second body electrical contact 168 may be provided or positioned at or near first end 116 of filter body 112. For instance, second body electrical contact 168 may be positioned adjacent to measurement module 160 when measurement module 160 is attached to filter body 112. Second body electrical contact 168 may be electrically connected with first body electrical contact 128. In detail, second body electrical contact 168 may receive electrical signals provided to filter body 112 via first body electrical contact 128. The electrical signals may be received at the one or more electronics components 135 and subsequently routed to second body electrical contact 168 (e.g., via a tertiary electrical path 169). As would be understood, multiple second body electrical contacts 168 may be provided, as well as multiple tertiary electrical paths 169.

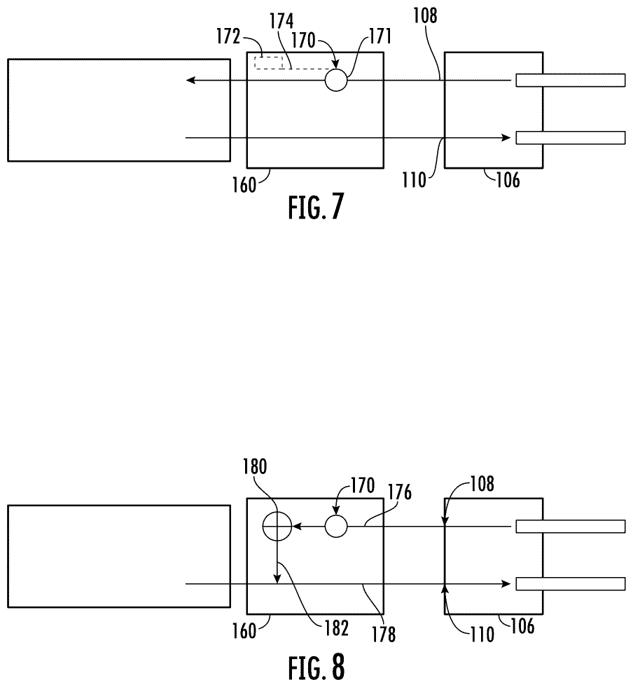

Referring now to FIGS. 7 through 10, schematic embodiments of a water filtration system 102 incorporating measurement module 160 are shown. FIG. 7 shows measurement module 160 in a disconnected state from filter body 112. Measurement module 160 may include a fluid flow measuring device 170. Fluid flow measuring device 170 may be configured to determine an amount of fluid passing through water filtration system 102. For at least one example, fluid flow measuring device 170 may be a flow meter 171. Flow meter 171 may be a device or sensor configured to measure, sense, calculate, or otherwise determine an amount or volume of liquid (e.g., water) that is supplied through water filtration system 102. For instance, flow meter 171 may determine a total amount of liquid dispensed from dispenser assembly 32 (e.g., through filter body 112) over a predetermined amount of time (e.g., over days, weeks, months, etc.). Flow meter 171 may then transmit the data including the volume of liquid dispensed to controller 34.

Measurement module 160 may include a module electrical contact 172. Module electrical contact 172 may be operably coupled with fluid flow measuring device 170. For instance, module electrical contact 172 may selectively send or receive signals (e.g., electrical signals) from fluid flow measuring device 170. A module electrical path 174 may be provided within measurement module 160. Module electrical path 174 may electrically connect module electrical contact 172 and fluid flow measuring device 170. As mentioned above with respect to electrical connection 126, in addition to providing power or in the alternative, one or more other signals for communication or sensing may also be provided between module electrical contact 172 and fluid flow measuring device 170.

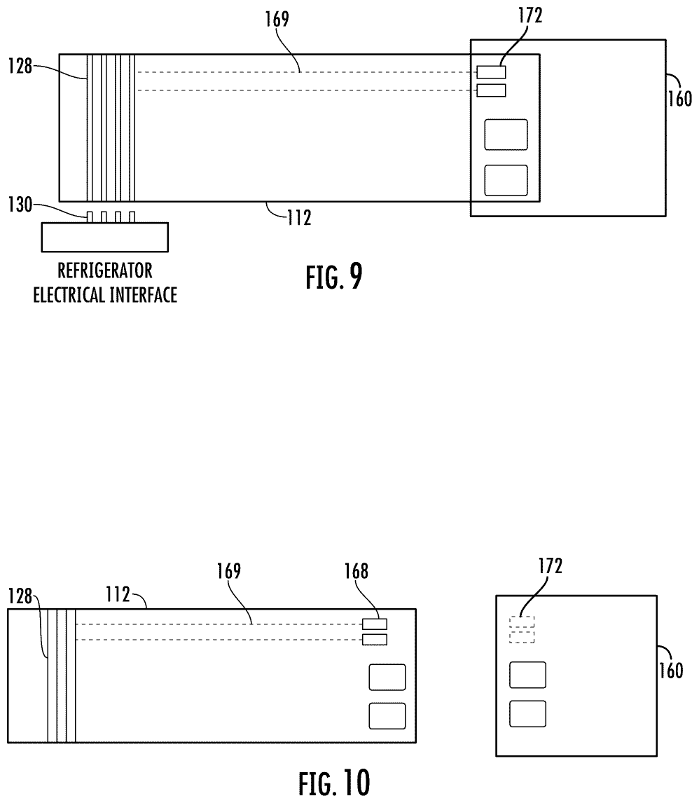

Module electrical contact 172 may be configured to operably connect or mate with second body electrical contact 168 (e.g., when measurement module 160 is connected to filter body 112). For instance, when filter body 112 is attached to (e.g., inserted into) measurement module 160, second body electrical contact(s) 168 may be aligned with module electrical contact 172 (e.g., along the radial direction R and the axial direction A, see FIG. 9). Electric signals may thus be transferred between second body electrical contact(s) 168 and module electrical contact(s) 172. Accordingly, power may be supplied to flow meter 171 from appliance 100 through filter body 112. Additionally or alternatively, signals from flow meter 171 (e.g., amount of fluid dispensed, etc.) may be provided to appliance 100 via filter body 112 through module electrical contact 172.

As mentioned above, filter body 112 may be at least partially received within measurement module 160 along the axial direction A. Thus, module electrical contact(s) 172 may be provided along an inner circumferential surface 173 of measurement module 160 (see FIG. 6). Thus, when filter body 112 is inserted into measurement module 160, module electrical contact(s) 172 may connect with second body electrical contact(s) 168.

Measurement module 160 may include a raw water inlet 176 and a treated water outlet 178. Raw water inlet 176 may be configured to fluidly couple to water inlet 108 of manifold 106 to receive water (e.g., municipal water) from appliance 100. Raw water inlet 176 may pass through measurement module 160 along the axial direction A. Raw water inlet 176 may be fluidly coupled with a water inlet of filter body 112. Accordingly, water supplied to raw water inlet 176 may flow into filter body 112 to be filtered. Treated water outlet 178 may be configured to fluidly couple to water outlet 110 of manifold 106. Treated water outlet 178 may pass through measurement module 160 along the axial direction A. Treated water outlet may be fluidly coupled with a water outlet of filter body 112. Thus, as would be expected, water filtered within filter body 112 may flow back into appliance 100 via treated water outlet 178.

Fluid flow measuring device 170 may be fluidly coupled to raw water inlet 176. For instance, fluid flow measuring device 170 may be installed, positioned, or provided along raw water inlet 176 such that water flowing through raw water inlet 176 is measured by fluid flow measuring device 170. Advantageously, an amount of water effectively filtered by filter body 112 may be determined or measured as it is supplied into measurement module 160. As mentioned above, the signals relating to the amount of water filtered may be transmitted back to appliance 100 (e.g., via module electrical contact 172, second body electrical contact 168, etc.). From there, the amount of water filtered may be displayed to a user (e.g., via an on board display, via a remote connected device, or the like).

According to some embodiments, measurement module 160 include a bypass valve 180. Bypass valve 180 may be fluidly coupled between raw water inlet 176 and treated water outlet 178. For instance, bypass valve 180 may be positioned along raw water inlet 176 and include a bypass channel 182. Bypass channel may include one or more tubes, pipes, or fluid lines through which fluid (e.g., water) may be directed from raw water inlet 176 to treated water outlet 178. Thus, water may bypass filter body 112 entirely. Bypass valve 180 may be positioned downstream from fluid flow measuring device 170. Bypass valve may be electrically connected with module electrical contact 172. Accordingly, signals may be transmitted between bypass valve 180 and appliance 100 via filter body 112.

Bypass valve may be opened such that water entering measurement module 160 via raw water inlet 176 flows through fluid flow measuring device 170, is diverted through bypass channel 182 into treated water outlet 178, and back into appliance 100. Fluid flow measuring device 170 may thus determine a baseline flow pressure from appliance 100 (or a municipal source) to be compared with a flow pressure through filter body 112. For instance, a user may initiate a test mode to open bypass valve 180 to determine the baseline flow pressure. A predetermined amount or volume of fluid (water) may then pass through fluid flow measuring device 170 and bypass valve 180 before being ejected from appliance 100 and discarded.

Bypass valve 180 may thus include a three-way valve having an inlet and two outlets (e.g., a first outlet toward filter body 112 and a second outlet toward bypass channel 182). Either of the first outlet or the second outlet may be selected to direct the water to filter body 112 or treated water outlet 178. In some instances, a second three-way valve is positioned along treated water outlet 178. The second three-way valve may include two inlets and an outlet. The two inlets may include a first inlet from filter body 112 and a second inlet from bypass channel 182. Either of the first inlet or the second inlet may be opened to receive water from filter body 112 or bypass channel 182. Accordingly, the second three-way valve may be electrically connected with module electrical contact 172.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A water filtration system for a domestic appliance, the domestic appliance comprising a receiving compartment, the water filtration system comprising:
a filter body defining an axial direction, a radial direction, and a circumferential direction, the filter body comprising a first body electrical contact configured to transfer electrical signals between the domestic appliance and the filter body and a second body electrical contact positioned opposite the first body electrical contact, the second body electrical contact being electrically connected with the first body electrical contact; and
a measurement module removably coupled to the filter body at a first axial end thereof, the measurement module being connectable to the domestic appliance, the measurement module comprising:
a module electrical contact selectively coupled with the second body electrical contact to transfer electrical signals between the measurement module and the filter body; and
a fluid flow measuring device configured to determine an amount of fluid passing through the water filtration system, the fluid flow measuring device receiving electrical power from the domestic appliance via the filter body.

2. The water filtration system of claim 1, wherein the measurement module comprises a raw water inlet and a treated water outlet.

3. The water filtration system of claim 2, wherein the fluid flow measuring device comprises a flow meter, and wherein the flow meter is fluidly coupled to the raw water inlet.

4. The water filtration system of claim 3, wherein the measurement module further comprises:
a bypass valve fluidly coupled between the raw water inlet and the treated water outlet, the bypass valve selectively directing fluid from the raw water inlet to the treated water outlet to bypass the filter body.

5. The water filtration system of claim 4, wherein the flow meter is positioned upstream from the bypass valve along the raw water inlet.

6. The water filtration system of claim 1, wherein the measurement module at least partially surrounds the filter body along the radial direction such that the filter body is selectively inserted into the measurement module along the axial direction.

7. The water filtration system of claim 1, wherein the module electrical contact comprises:
a plurality of module electric contacts spaced apart from each other along the circumferential direction.

8. The water filtration system of claim 1, wherein the fluid flow measuring device is configured to transmit an electrical signal to the domestic appliance, the electrical signal comprising the amount of fluid passing through the water filtration system.

9. The water filtration system of claim 1, wherein the module electrical contact is provided along an inner circumferential surface of the measurement module.

10. A measurement module for a water filtration system, the water filtration system defining an axial direction, a radial direction, and a circumferential direction, the water filtration system comprising a filter body having at least one body electrical contact, the measurement module comprising:
a module electrical contact selectively coupled with the at least one body electrical contact to transfer electrical signals between the measurement module and the filter body; and
a fluid flow measuring device configured to determine an amount of fluid passing through the water filtration system, the fluid flow measuring device receiving electrical power from the filter body.

11. The measurement module of claim 10, wherein the measurement module comprises a raw water inlet and a treated water outlet.

12. The measurement module of claim 11, wherein the fluid flow measuring device comprises a flow meter, and wherein the flow meter is fluidly coupled to the raw water inlet.

13. The measurement module of claim 12, wherein the measurement module further comprises:
a bypass valve fluidly coupled between the raw water inlet and the treated water outlet, the bypass valve selectively directing fluid from the raw water inlet to the treated water outlet to bypass the filter body.

14. The measurement module of claim 13, wherein the flow meter is positioned upstream from the bypass valve along the raw water inlet.

15. The measurement module of claim 10, wherein the measurement module at least partially surrounds the filter body along the radial direction such that the filter body is selectively inserted into the measurement module along the axial direction.

16. The measurement module of claim 10, wherein the module electrical contact comprises:
a plurality of module electrical contacts spaced apart from each other along the circumferential direction.

17. The measurement module of claim 10, wherein the fluid flow measuring device is configured to transmit an electrical signal, the electrical signal comprising the amount of fluid passing through the water filtration system.

18. The measurement module of claim 10, wherein the module electrical contact is provided along an inner circumferential surface of the measurement module.
